(19) United States
(12) Patent Application Publication
(10) Pub. No.: US 2006/0231676 A1
(43) Pub. Date: Oct. 19, 2006

(54) Vertical take-off aircraft - E

(76) Inventor: Tom Kusic, Maribyrnong (AU)

Correspondence Address: TOM KUSIC, PO BOX 932, MELBOURNE, VIC., 3001, AU

(21) Appl. No.: 11/446,231

(22) Filed: Jun. 5, 2006

Related U.S. Application Data
(63) Continuation-in-part of application No. 09/180,925, filed on Nov. 16, 1998, now abandoned.

(51) Int. Cl. B64C 27/00

(52) U.S. Cl. 244/17.11

(57) ABSTRACT

A vertical take-off aircraft is disclosed. Looking at the aircraft it can be seen that the aircraft comprises a main rotor assembly 1 at the top of the aircraft which consists of an assembly of blades 2, 3 and a rotor 4. Rotation of the main rotor assembly 1 is achieved by using a power plant 5. The main power plant is connected to the main body 6 of the aircraft by a tilt enabling joint 7. The tilt enabling joint 7 allows tilting of the main power plant 5 relative to the main body 6 of the aircraft to occur in a controlled manner during flight. A universal joint 8 is used to allow tilting to occur. The tilt enabling joint 7 is fitted with a combination of hydraulic actuators 9, 10 and springs 11, 12 and 13 that allow the tilting of the tilt enabling joint 7 to be controlled. When the main power plant 5 is tilted, the main rotor assembly 1 is tilted with it. Tilting of the main power plant 5 thus initiates changes in the direction of travel of the aircraft without the need to change the pitch angles of the blades 2 and 3. To counter the rotational force exerted on the main body 6 of the aircraft by the rotation of the main rotor assembly 1, an additional power plant 15 is attached to the main body aircraft, which rotates an additional rotor assembly 16. The additional rotor assembly consists of blades 17 and 18, and a rotor 19. Rotation of the additional rotor assembly pushes air in a primarliy horizontal direction by way of the pitch of the blades 17 and 18. A grasping mechanism 5a is positioned on the side of the main body.

### CROSS REFERENCE TO RELATED APPLICATIONS

This is a continuation-in-part patent application, being a continuation-in-part of the U.S. patent application Ser. No. 09/180,925.

### STATEMENT REGARDING FEDERALLY SPONSORED RESEARCH OR DEVELOPMENT

Not applicable.

### REFERENCE TO SEQUENCE LISTING

Not applicable.

### BACKGROUND OF THE INVENTION

### FIELD OF THE INVENTION

This invention relates to the vertical take-off field of aviation.

### BRIEF SUMMARY OF THE INVENTION

There are many helicopters in existence today. However, helicopters rely on variable pitch rotor blades to maintain control and provide vertical lift, and the construction of helicopters with variable pitch rotors has resulted in limited operational ability when helicopters are used in forest areas, at high altitudes where the air is thin and when operating near steep mountains. Pitch varying mechanisms require frequent time consuming and expensive maintenance and a failure in the pitch varying mechanism on a helicopter often results in disaster due to instantaneous loss of control that cannot be overcome.

The present invention overcomes the need for varying the pitch of rotor blades while at the same time allowing vertical lift on take-off and directional control by providing a vertical take-off aircraft using an main rotor assembly at the top of the aircraft, which main rotor assembly consists of an assembly of blades and a rotor.

Vertical lift is obtained by the rotation of the main rotor assembly thereby forcing air in a downward direction by way of the angle of pitch of the blades. Rotation of the main rotor assembly is achieved using a power plant located between the main body of the aircraft and the said blades, which power plant is the main power plant forming part of the aircraft, and which main power plant is connected to the main body of the aircraft by a tilt enabling joint. The tilt enabling joint consists of numerous components, some of which provide the means to support the main body of the aircraft below the main power plant and allow the tilt enabling joint to have a tilting ability while other components provide the means to control and cause tilting motions in the tilt enabling joint during flight, thereby enabling controlled tilting to occur, such that the main power plant and the main rotor assembly can be tilted together as a unity relative to the main body of the aircraft in a controlled manner during flight, thereby providing a means for controlling the directional travel of the aircraft during flight and changing the aircraft's direction of travel.

During flight, rotational stability of the main body of the aircraft is maintained by means of an additional power plant attached to the aircraft which rotates an additional rotor assembly, thereby pushing air primarily in a horizontal direction to counter the rotational force exerted on the main body of the aircraft by the rotation of the upper main rotor assembly, which said additional rotor assembly consists of an assembly of blades and a rotor.

As can be seen from the diagrams that follow, the present invention makes many of the components needed to construct a conventional helicopter obsolete, while providing an aircraft that can perform not only tasks normally performed by conventional helicopters but also other tasks that conventional helicopters cannot perform due to their configuration necessitated by variable pitch rotors—such as landing among trees, and grasping trees for stability with grasping mechanisms.

### BRIEF DESCRIPTION OF THE SEVERAL VIEWS OF THE DRAWINGS

Embodiments of the invention will now be described by way of example with reference to the accompanying drawings, of which:

FIG. 1 is a view of the left side of one form of aircraft according to this invention.

FIG. 2A is a view of the left side of another form of aircraft according to this invention.

FIG. 2B is a view of the right side of the aircraft of FIG. 2A.

FIG. 3 is a view of the rear of yet another form of aircraft according to this invention.

FIG. 4 is the left side view of the aircraft of FIG. 3.

FIG. 5A is an enlarged view of a universal joint.

FIG. 5B is a rotated view of the universal joint of FIG. 5A.

FIG. 6 shows the main power plant comprising two engines.

FIG. 7 shows the additional power plant comprising two engines.

FIG. 8 shows one form of the aircraft with the additional power plant and additional rotor assembly replaced by a jet engine.

FIG. 9 shows one form of the aircraft with the additional power plant and additional rotor assembly connected to the upper section of a tilt enabling joint.

FIG. 10 shows how variable pitch fins could be positioned on the aircraft.

FIG. 11 shows how one form of the aircraft could be used to evacuate people from the side of a building.

FIG. 12 shows how the main body of the aircraft of FIG. 9 could make contact with the side of steep mountain while the rotors are kept at a safe distance.

FIG. 13 shows that by keeping the main rotor at a large distance from the main body of the aircraft, the aircraft would be able to land among trees while the main rotor is kept above the trees, and grasp surrounding trees with grasping mechanisms.

FIG. 14 shows a enlarged view of a grasping mechanism used by the aircraft of FIG. 13.

FIG. 15 shows that as many as eight rotor blades can be assembled around a small rotor hub when blade pitch varying components are not required.

### DETAILED DESCRIPTION OF THE DRAWINGS

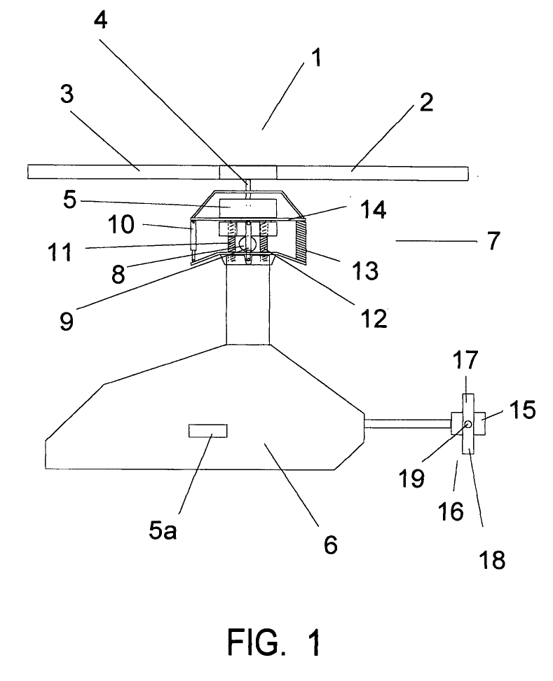

FIG. 1 shows one form of aircraft according to this invention.

Looking at the aircraft in FIG. 1 it can be seen that the aircraft comprises a main rotor assembly 1 at the top of the aircraft, which rotor assembly consists of an assembly of blades 2, 3 and a rotor 4. Rotation of the main rotor assembly is achieved by using a power plant 5, which is the main power plant on the aircraft. Vertical lift is obtained by the rotation of the main rotor assembly 1. Rotation of the main rotor assembly 1 forces air in a downward direction by way of the angle of pitch of the blades 2 and 3. The blades 2 and 3 are above the main power plant. The main power plant is connected to the main body 6 of the aircraft by a tilt enabling joint 7. The tilt enabling joint 7 allows tilting of the main power plant 5 relative to the main body 6 of the aircraft to occur in a controlled manner. A universal joint 8 is used to allow tilting to occur. The tilt enabling joint 7 is fitted with a combination of hydraulic actuators 9, 10 and springs 11, 12 and 13 that allow the tilting of the tilt enabling joint 7 to be controlled. As hydraulic pressure is applied to the front hydraulic actuator 10, it expands and in so doing tilts the upper section 14 of the tilt enabling joint 7 rearward, thereby compressing the rear spring 13. As hydraulic pressure to the front hydraulic actuator 10 is released, the rear spring 13 acts to tilt the upper section 14 of the tilt enabling joint 7 forward. When the main power plant 5 is tilted, the main rotor assembly 1 is tilted with it. Tilting of the main power plant 5 thus initiates changes in the direction of travel of the aircraft without the need to change the pitch angles of the blades 2 and 3. To counter the rotational force exerted on the main body 6 of the aircraft by the rotation of the main rotor assembly 1, FIG. 1 shows an additional power plant 15 attached to the main body of the aircraft, which rotates an additional rotor assembly 16. The additional rotor assembly consists of blades 17 and 18, and a rotor 19. Rotation of the additional rotor assembly pushes air in a primarliy horizontal direction by way of the pitch of the blades 17 and 18. By forcing air to travel in a horizontal direction, the additional rotor assembly acts to counter the rotational force exerted on the main body 6 of the aircraft by the rotation of the main rotor assembly 1. A grasping mechanism 5a is shown positioned on the side of the main body of the aircraft.

The Springs 11, 12 and 13 shown in FIG. 1 can be replaced with gas pressurised struts, with the struts fitted in the locations where the springs are located in FIG. 1.

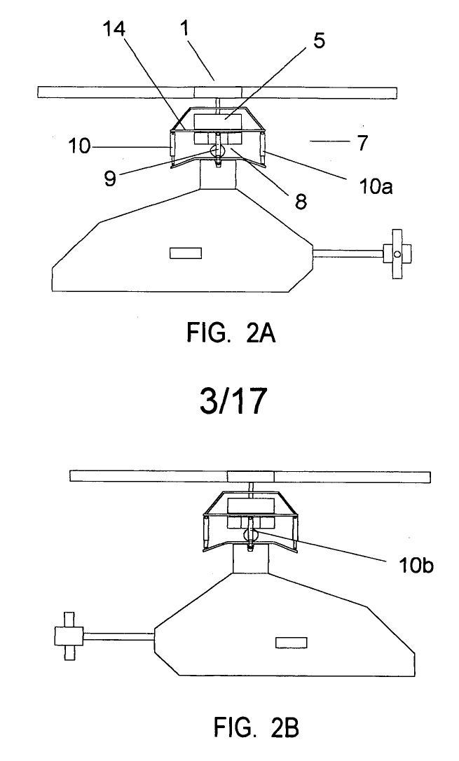

FIG. 2A shows a tilt enabling joint 1 consisting of hydraulic actuators 9, 10 and 10a being used to control the direction and angle of tilt, and a universal joint 8. As hydraulic pressure is applied extend to one hydraulic actuator 10 to extend it, hydraulic pressure on the hydraulic actuator 10a located directly on the opposite side of the universal joint 8 is released, allowing that hydraulic actuator 10a to contract, thereby causing controlled tilting of the upper section of the tilt enabling joint.

The movement can be reversed by applying hydraulic pressure to hydraulic actuator 10a and releasing hydraulic pressure on hydraulic actuator 10. With the main power plant 5 attached to the upper section 14 of the tilt enabling joint, when the upper section 14 of the tilt enabling joint is tilted so too is the main power plant 5 and with it the main rotor assembly 1. FIG. 2B shows the aircraft of FIG. 2A rotated horizontally 180 degrees to show the hydraulic actuator 10b on right side of the tilt enabling joint.

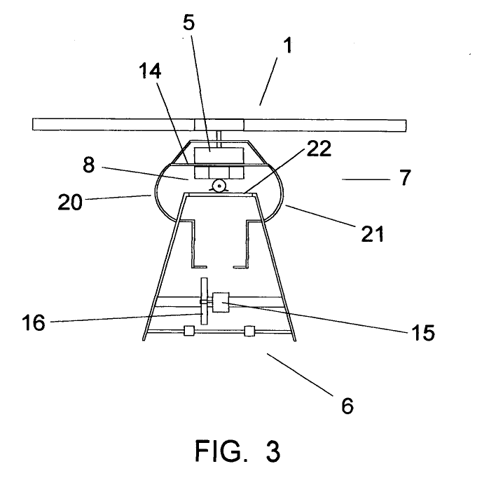

FIG. 3 shows the rear view of another form of the aircraft with handles 20 and 21 forming part of the tilt enabling joint 7. The handles 20 and 21 are attached to the upper section 14 of the tilt enabling joint. The tilting ability of the tilt enabling joint is achieved by the universal joint 8. The aircraft has a main rotor assembly 1 which is rotated by a main power plant 5. An additional power plant 15 is used to rotate the additional rotor assembly 16. Directional control of the aircraft during flight is achieved by controlled tilting of the upper section 14 of the tilt enabling joint relative to the lower section 22 of the tilt enabling joint, thereby tilting the main power plant 5 and main rotor assembly 1.

Controlled tilting of the upper section 14 of the tilt enabling joint during flight is enabled by the handles 20 and 21. Moving the handles 20 and 21 relative to the main body of the aircraft 6 would be capable of causing a forward and rearward tilting to the upper section of the tilt enabling joint, as well as sideway tilting.

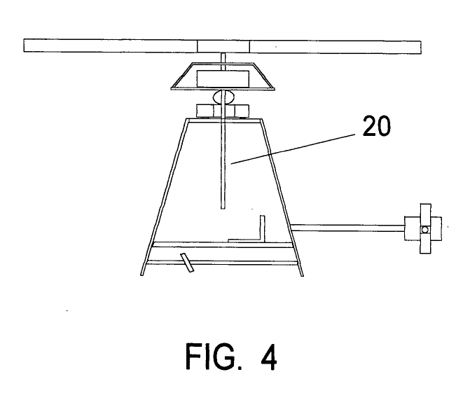

FIG. 4 is the left side view of FIG. 3, showing the position of the left handle 20 from a side view.

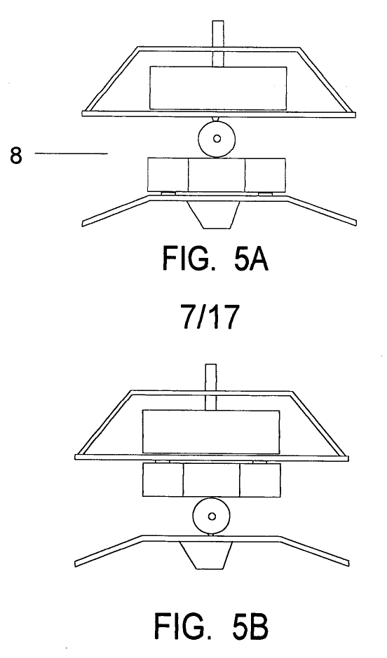

FIGS. 5A and 5B shows the universal joint 8 of the tilt enabling joint of FIG. 1. FIG. 5B is FIG. 5A rotated 90 degrees horizontally.

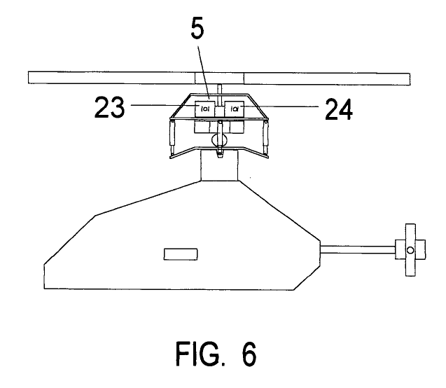

FIG. 6 shows a version of the aircraft with the main power plant 5 comprising two engines 23 and 24. The main power plant in FIG. 1 comprised a single engine.

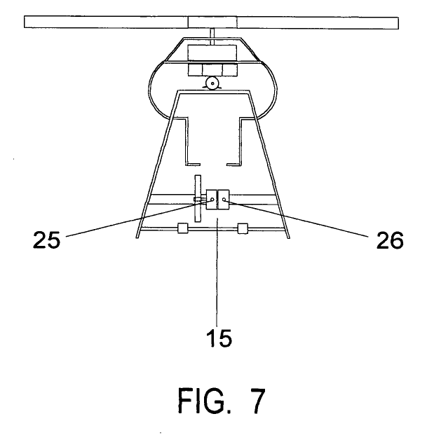

FIG. 7 shows the rear of a version of the aircraft of FIG. 3 with additional power plant 15 comprising two engines 25 and 26. The additional power plant of the aircraft in FIG. 3 comprised a single engine.

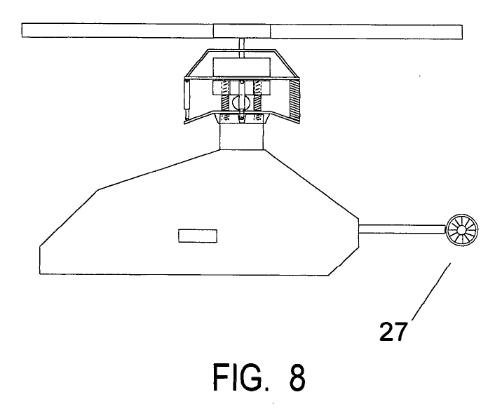

FIG. 8 shows a version of the aircraft of FIG. 1 with a jet engine 27 replacing the additional power plant 15 shown in FIG. 1 and the additional rotor assembly 16 also shown in FIG. 1. The jet engine is shown connected to the main body of the aircraft. In another form of the aircraft the jet engine is connected to the upper section of the tilt enabling joint. It could also be connected to the main power plant. The jet engine shown is a turbojet. In another form of the aircraft, the jet engine is a turbofan.

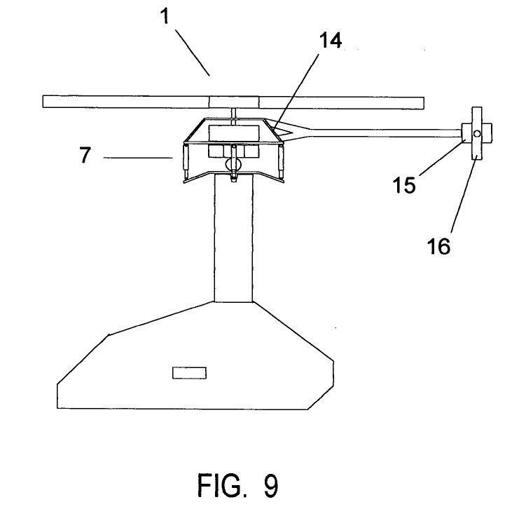

FIG. 9 shows a version of the aircraft where the additional power plant 15 is attached to the upper section 14 of the tilt enabling joint 7, with the additional rotor assembly 16 attached to the additional power plant 15. This feature would allow both the main rotor assembly 1 and the additional rotor assembly 16 to stay high above the ground when the aircraft has landed in a forest. In another form of the aircraft, the additional power plant could be connected to the main power plant.

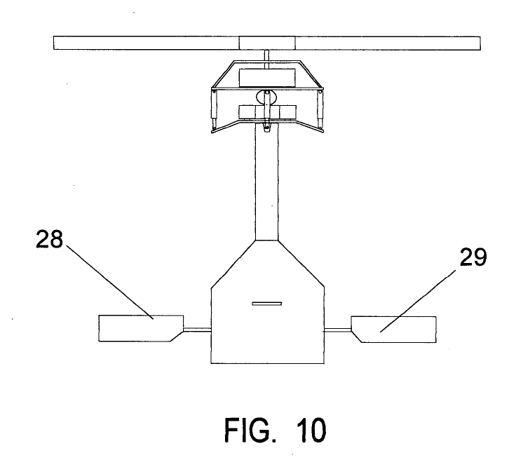

FIG. 10 shows the front of an aircraft similar to the one shown in of FIG. 9 and how variable pitch fins 28 and 29 could be positioned on the aircraft. The variable pitch fins could augment control of the aircraft, and could be used as airbrakes. They could also provide lift during high speed forward flight, such as wings on an airplane, since downwash from the main rotor assembly 2 would be directed to the rear of the aircraft, due to the tilting of the main rotor assembly in a forward direction and the distance of the main rotor assembly from the variable pitch fins.

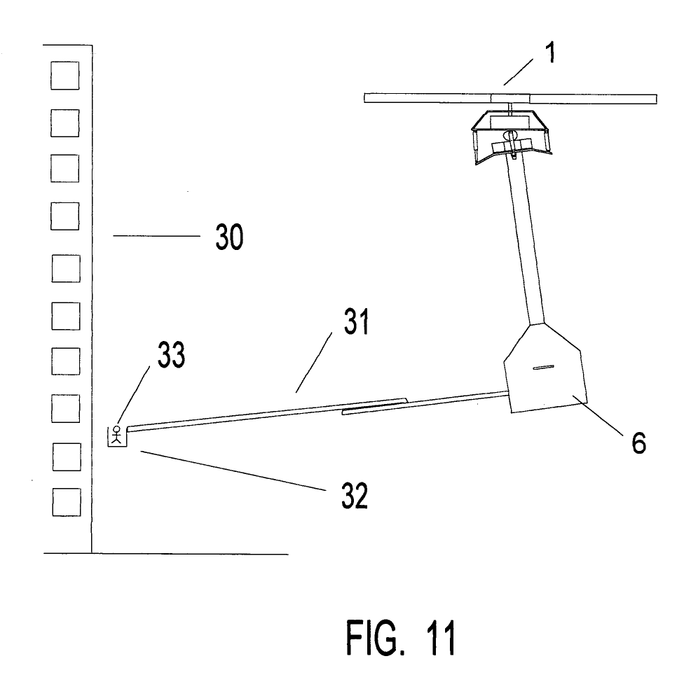

FIG. 11 shows how an aircraft according to this invention could be used as an evacuation vehicle for persons trapped in a building 30. An extension ladder 31 secured to the main body 6 of the aircraft is shown in extended form, with a basket 32 at the end of the extension ladder. FIG. 11 shows how a person 33 could be rescued from the building. The large distance between the main rotor and the main body of the aircraft makes the main body 6 of the aircraft act like a keel on a yaght, so that an extension ladder has a minimal effect on the ability to control the aircraft. The main body could be tilted slightly, while the main rotor assembly 1 could be maintained in a level position.

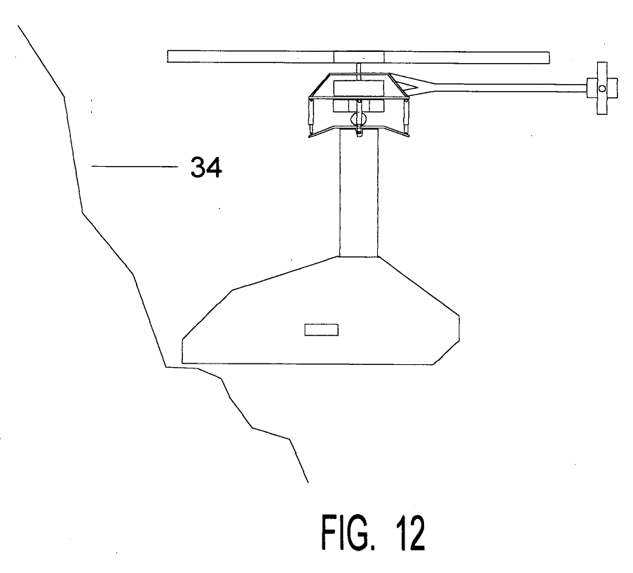

FIG. 12 shows how the aircraft of FIG. 9 could be used to quickly unload supplies on the side of a steep mountain 34, or quickly evacuate injured persons without having to use a winch. The relatively short distance between the main rotor and the main body of a conventional helicopter would prevent the main body of a conventional helicopter being able to make contact with such a steep mountain without a high risk of the rotor blades impacting with the mountain.

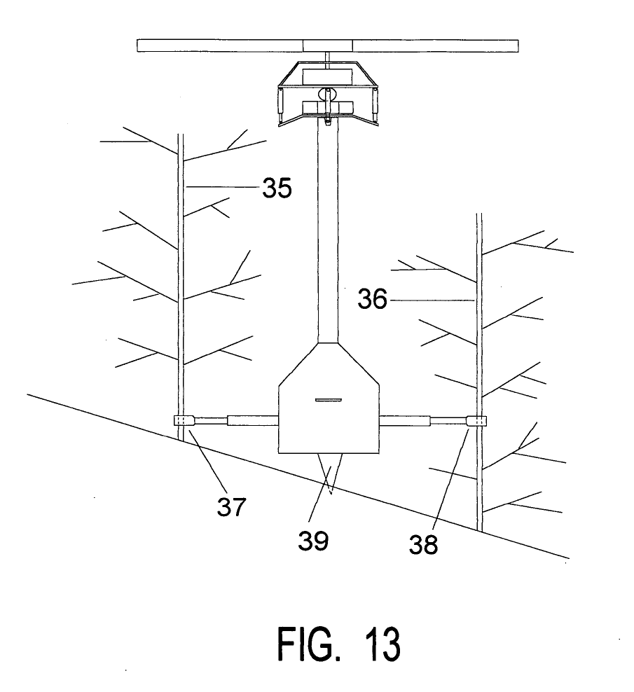

FIG. 13 shows how the aircraft of FIG. 11 could land between trees 35 and 36, while the main rotor assembly is kept above the tops of the trees. Cargo could be loaded and unloaded or injured persons evacuated without using a winch. Grasping mechanisms 37 and 38 are shown grasping trees 35 and 36 respectively, providing support and stablility for the aircraft while a sharpened section 39 protruding beneath the main body bears some of the weight of the aircraft.

FIG. 9 showed the aircraft with the additional power plant 15 and the additional rotor assembly 16 connected to the upper section of the tilt enabling joint. By attaching the additional rotor assembly 16 and the additional power plant 15 to the upper section of the tilt enabling joint, the additional rotor assembly could be kept above trees when the aircraft is landed amongst trees as shown in FIG. 13.

The aircraft could land in an area such as a forest where the rotors of a conventional helicopter would impact with the trees. The aircraft would not require a cleared landing zone to land in a forest. In a war, the possible landing area would be less predictable by an enemy force, reducing the risk of an ambush around a cleared landing zone. If the aircraft was operated on a battle field and the aircraft was targeted by a heat seaking missile during flight, having the main power plant and the additional power plant located away from the main body of the aircraft would provide the occupants with a greater chance of survival than if the main power plant was attached directly to the main body of the aircraft if the missile caused a fire at the main power plant. The additional power plant 15 and additional rotor assembly could also be attached to the base of the tilt enabling joint, or the main power plant.

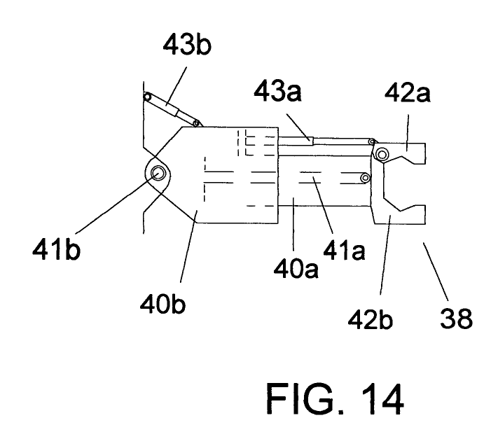

FIG. 14 shows the grasping mechanism 38 from FIG. 13 as viewed from above. The grasping mechanism comprises a moveable component 42a which can be moved towards a rigid component 42b by hydraulic actuator 43a. Expansion of the hydraulic actuator 43a creates a grasping motion between 42a and 42b. The grasping mechanism is connected to the main body of the aircraft by a hollow beam 40a, which can be extended outward by means of hydraulic actuator 41a, such that the beam 40a can operate in a telescopic manner sliding in and out of an enclosure 40b. The enclosure 40b is connected to the main body of the aircraft by a bolt 41b, which enables the enclosure 40b to swivel relative to the main body. The swiveling motion of the enclosure 40b is contolled by hydraulic actuator 43b. Hydraulic actuator 43b is connected to the enclosure 40b and the main body of the aircraft.

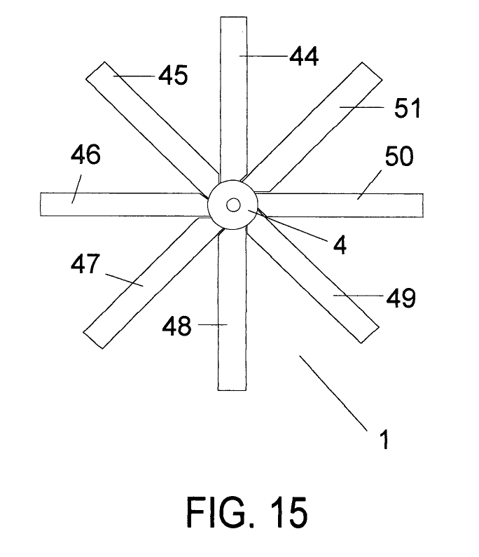

FIG. 15 shows how eight rotor blades 44, 45, 46, 47, 48, 49, 50, 51, can be assembled around a rotor 4 when space is not required for blade pitch varying components. This number of rotor blades would allow the rotor assembly 1 to be rotated at a lower rate of revolution than a rotor assembly with fewer blades, to achieve the same lifting ability, resulting in a relatively quieter aircraft. Having a high number of rotor blades would help the aircraft to operate in high altitude mountainous regions or hot regions, where the air is thin.

1. A vertical take-off aircraft, comprising a main rotor assembly at the top of the aircraft, which said main rotor assembly comprises an assembly of blades and a rotor, and such that the said main rotor assembly is above a main body of the aircraft, with vertical lift being achieved by means of at least one power plant rotating the main rotor assembly thereby forcing air in a downward direction by way of the blades in the main rotor assembly, and which said blades are above the at least one power plant, and which said at least one power plant is connected to the main body of the aircraft by a tilt enabling joint, such that the main rotor assembly and the at least one power plant can be tilted together as a unity in a plurality of directions and angles relative to the main body of the aircraft, in a controlled manner, such that the direction of travel of the aircraft can be altered by altering the direction of tilt of the at least one power plant relative to the main body of the aircraft, and which said tilt enabling joint is connected to the main body of the aircraft, with an additional rotor assembly, consisting of an assembly of blades and a rotor, connected to the aircraft, which said additional rotor assembly is used to force air to travel in a horizontal direction, for which said additional rotor assembly rotation is achieved by means of a at least one additional power plant, such that by forcing air to travel in a horizontal direction, relative to the main body of the aircraft, a rotational force exerted on the main body of the aircraft by rotation of the main rotor assembly can be countered, and said aircraft comprises a means to grasp at least one tree that is growing in a forest such that the aircraft is able to gain support from the at least one tree by said means grasping the at least one tree.
